(19) United States
(12) Patent Application Publication
(10) Pub. No.: US 2019/0187297 A1
(43) Pub. Date: Jun. 20, 2019

(54) SYSTEM AND METHOD FOR LOCATING A MOVING OBJECT

(71) Applicant: SZ DJI TECHNOLOGY CO., LTD., Shenzhen (CN)

(72) Inventors: Peiliang LI, Shenzhen (CN); Jie QIAN, Shenzhen (CN); Cong ZHAO, Shenzhen (CN); Xuyang FENG, Shenzhen (CN)

(21) Appl. No.: 16/280,648

(22) Filed: Feb. 20, 2019

Related U.S. Application Data
(63) Continuation of application No. PCT/CN2016/096160, filed on Aug. 22, 2016.

(51) Int. Cl. G01S 19/49

(52) U.S. Cl. CPC G01S 19/49

(57) ABSTRACT

A method for locating a moving object includes obtaining an approximate displacement of the moving object between a first time point and a second time point based on location measurements of the moving object at the first time point and the second time point, processing inertial measurements of the moving object at a plurality of interval time points between the first time point and the second time point to acquire movement characteristics of the moving object between the first time point and the second time point, and determining an estimated displacement of the moving object at one of the interval time points between the first time point and the second time point based on the acquired movement characteristics of the moving object and the approximate displacement of the moving object between the first time point and the second time point.

### CROSS-REFERENCE TO RELATED APPLICATION

This application is a continuation of International Application No. PCT/CN2016/096160, filed on Aug. 22, 2016, the entire contents of which are incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

Determining the location of an object, in particular a moving object, is useful for navigation and has also seen increased use in various applications for unmanned aerial aircrafts (UAV). When the moving object moves at a high speed or changes direction frequently, however, precision in location determination is resource-intensive and is difficult to achieve.

Presently, a solution to high-precision positioning requires a high-precision global positioning system (GPS) receiver. Such a GPS receiver, however, is bulky, expensive, and only updates slowly. Such a solution is not practical for many applications, such as in recreational aerial tracking or photography. This is at least in part because the GPS unit in a handheld device typically has low precision and low update frequency (e.g., less than 1 Hz).

In aerial tracking, an alternative to using a GPS receiver is the use of image recognition. Image recognition, however, is also resource-intensive and its accuracy is limited by computational power, lighting conditions, and other environmental factors.

### SUMMARY

Described are systems, computer-readable media, and methods useful for locating a moving object such as a walking or running individual. A “low-frequency measurement” of the locations of the moving object can be made such as with a GPS receiver. A GPS receiver suitable for this measurement does not need to be highly accurate and can be a low-cost GPS unit found in consumer smart phones. An approximate displacement can be derived from such measured locations.

Meanwhile, a plurality of inertial measurements can be made between two time points at which the low-frequency measurements are made. The inertial measurements take place at a higher frequency (“high-frequency measurement”) and can include information such as acceleration. The inertial measurement can be made with a sensing unit which can include components such as accelerometers, gyroscopes, magnetometers, or the combinations thereof. From the acceleration data, certain movement characteristics (e.g., speed) of the moving object can be acquired. The movement characteristics can then be used to calculate another displacement of the moving object, which can be referred to as an inertial measurement displacement (IM displacement).

Consider that the IM displacement can be calculated at relatively high frequency and the approximate displacement can be determined with relatively low accumulative error, the combination of both can lead to estimation of the moving object's displacement and location at high frequency and high accuracy. The combination can take into consideration the errors of each of the respective measurements. Further, the acceleration data can be subjected to noise reduction processing, such as with a low-pass filter, to improve displacement estimation.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

Certain features of various embodiments of the present technology are set forth with particularity in the appended claims. A better understanding of the features and advantages of the technology will be obtained by reference to the following detailed description that sets forth illustrative embodiments, in which the principles of the disclosure are utilized, and the accompanying drawings of which:

FIG. 1A illustrates a method of determining a running person's displacement from a time point (L1) to a second time point (L2);

FIG. 1B shows an example in which the moving object is a walking person on an uneven surface;

FIG. 1C shows that the approximate displacement of a moving object can also be determined with a device (e.g., a UAV) not associated with the moving object;

FIG. 2 illustrates an acceleration curve obtained from inertial measurements;

FIGS. 3A and 3B illustrate two different ways of combining an approximate displacement and a displacement estimated with inertial measurements to arrive at a combined estimated displacement;

FIG. 4 is an example flow chart for one embodiment of the disclosed displacement estimation methodology;

FIG. 5 is an example flow chart for adjusting the movement of a tracking platform for tracking a moving object;

FIG. 6 illustrates one embodiment of a method of the present disclosure; and

FIG. 7 illustrates another embodiment of a method of the present disclosure.

### DETAILED DESCRIPTION

Certain description as follows uses an unmanned aerial vehicle (UAV) as an example for a movable object. It will be apparent to those skilled in the art that other types of movable object can be used without limitation.

The present disclosure, in one embodiment, provides systems and methods for determining the location of a moving object. The term “location” as used herein may refer to a location relative to the earth (“absolute location”) or a location relative to a reference object such as a monitoring device (“relative location”). In some scenarios, determining the location of a moving object at a present time point can be achieved by determining a displacement of the object from an earlier time point to the present time point provided that the location of the object at the earlier time point is known or can be measured.

An example method of the present disclosure for determining the displacement of a moving object takes as input two measurements for the moving object, which can be referred to as a “low-frequency measurement” and a “high-frequency measurement,” respectively. It is noted that the low and high frequencies in these terms are used for the purpose of convenience, and do not necessarily reflect the relationship between the measurements or the capability of each measurement or each associated device.

As further described below, a low-frequency measurement can be made by, for instance, a low-precision GPS unit in a handheld device associated with the moving object, or a remote device that tracks the moving object by suitable means. Such a low-frequency measurement, in some scenarios, is updated relatively infrequently but does not incur accumulative errors. In other words, if the error for a first measurement is about 10 meters, after 100 such measurements, the error is not likely going to be much greater than 10 meters.

The high-frequency measurement, in some scenarios, can be carried out more frequently than the low-frequency measurement. Such a high-frequency measurement, however, does not necessarily reveal the location of the moving object by itself. Rather, the high-frequency measurement, in some scenarios, concerns the acceleration, speed, moving direction, and/or displacement of the moving object. Nevertheless, such acceleration, speed, moving direction, and/or displacement, when used in combination with the location of the moving object prior to the movement, can determine the current location of the moving object. Further, since the high-frequency measurement can be carried out more frequently, it provides a frequent means to determine the location or displacement of the moving object.

At appropriate time or when needed, such determined location or displacement can be verified, corrected or adjusted. The verification, correction or adjustment can be made with reference to a location determined by the low-frequency measurement. The combinatory use of both a low-frequency measurement and a high-frequency measurement, therefore, can provide a high-frequency and high-precision means for determining the location or displacement of a moving object.

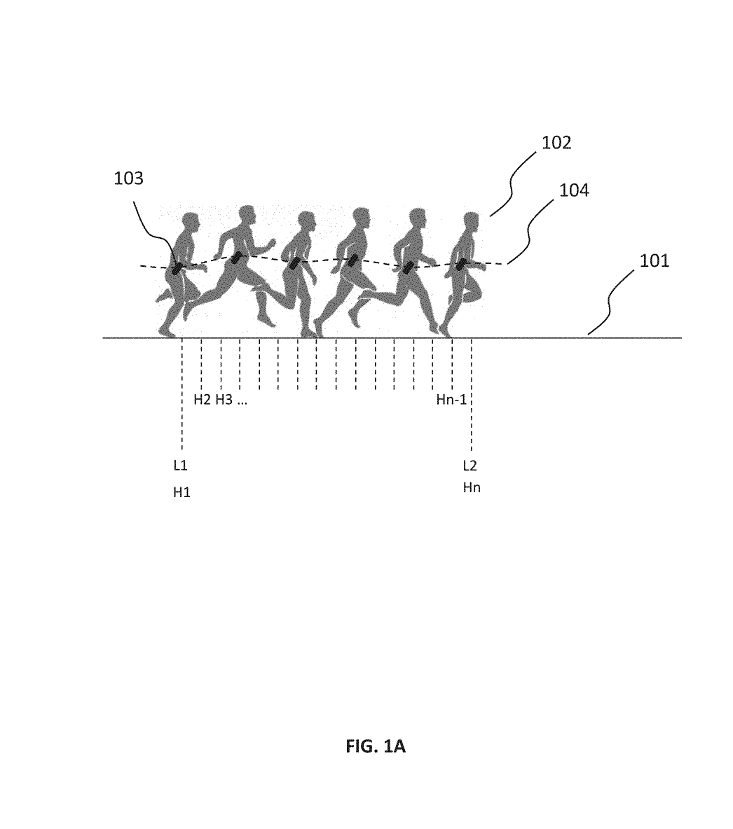

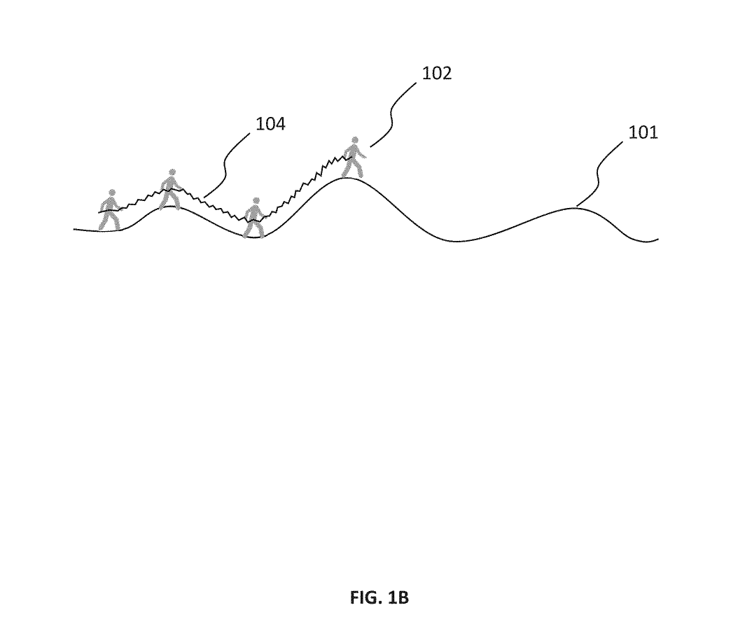

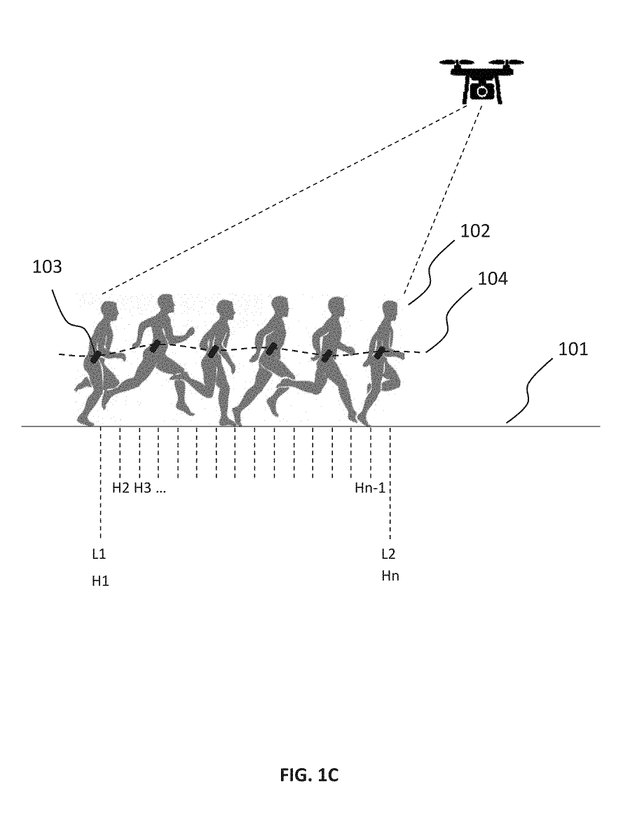

With reference to FIG. 1A, a person 102 moves on a surface 101 from the left to the right. The person carries a handheld device 103 (e.g., a smartphone that contains an inertial measurement unit (IMU)) capable of making inertial measurements. Here, either the person or the handheld device can be considered a moving object for which a displacement is to be determined. For purpose of illustration, the person is treated as the moving object in this example. The inertial measurements in this context can be considered a high-frequency measurement.

An approximate displacement can be obtained for the person 102 between a first time point (L1) and a second time point (L2). This approximate displacement does not need to be highly precise and the measurement does not need to be frequent. In terms of precision, a typical GPS receiver in a smartphone can suffice. In one instance, the measurement of the approximate displacement can have an error of not greater than about 30 meters, about 25 meters, about 20 meters, about 15 meters, or about 10 meters. In one scenario, the measurement of the approximate displacement can have an error of greater than about 1 meter, 2 meters, 3 meters, 4 meters, 5 meters, 6 meters, 7 meters, 8 meters, 9 meters, 10 meters, 15 meters or 20 meters. The measurement of the approximate displacement in this context can be considered a low-frequency measurement, therefore.

In some instances, the approximate displacement is obtained with a global positioning system (GPS) receiver. A GPS receiver is a device that can receive information from a GPS satellite in a global navigation satellite system (GNSS) and uses such information to determine a location that is relative to the satellite and to the earth around which the satellite orbits. There are a variety of GPS receives that can work with different GNSS systems.

Non-limiting examples of GNSS systems include the United States Global Positioning System (GPS), the Global Navigation Satellite System (GLONASS), the Indian Regional Navigation Satellite System (IRNSS), the Chinese BeiDou Navigation Satellite System (BeiDou-2), and the European Galileo navigation satellite system (GALILEO).

The approximate displacement does not have to be obtained with a device that is physically associated with the moving object, however. For instance, as illustrated in FIG. 1C, an UAV coupled to a camera flies above the surface 101 and the person 102 tracks the movement of the person. If the UAV is aware of its own position, using the relative distance and direction of the person to the UAV, the UAV can provide an estimate of the approximate displacement of the person.

As provided, the measurements of the approximate displacement do not need to be highly frequent. For instance, the time period between L1 and L2 can be at least ⅕ second, ¼ second, ⅓ second, ½ second, ⅔ second, ¾ second, or 1 second.

The inertial measurements, by contrast, can be made at a plurality of time points between the first time point and the second time point. As shown in FIG. 1A, between the first time point L1 and the second time point L2, the inertial measurements of the moving object are made at a number (n) of intermediate time points, H1, H2 . . . Hn. The frequency of the inertial measurements is therefore n times of that of the approximate displacement measurement.

In some instances, the frequency of the inertial measurements is higher than that for the approximate displacement measurements. For instance, the frequency of the inertial measurements is at least about 10 Hz, at least about 20 Hz, at least about 30 Hz, at least about 40 Hz, at least about 50 Hz, at least about 60 Hz, at least about 70 Hz, at least about 80 Hz, at least about 90 Hz, or at least about 100 Hz.

The inertial measurements may include accelerations at one or more dimensions or directions. As readily appreciated in the art, such inertial measurements can be obtained with a sensing unit (sensor), which can include, for instance, an accelerometer, a gyroscope, a magnetometer, or the combinations thereof. In some instances, various devices, including handheld devices such as smart phones, can include an inertial measurement unit (IMU).

The inertial measurements in certain situations are particularly useful for calculation of a displacement, such as when the moving object frequently changes speed and/or direction of its movement. A walking or running (or otherwise moving) individual, whether a human, an animal, a bird (flying), a fish (swimming), or a robot, is a suitable example. As illustrated in FIG. 1A, the person 102 carries a device 103 that contains an IMU which moves up and down, and possibly with left and right motions, to form a movement waveform 104 along with an acceleration curve. The vertical and side movements, however, may be considered noise and need to be removed or reduced before the data are used for calculating the displacement of the person.

In another example, as shown in FIG. 1B, the person 102 walks on an uneven/curved surface 101, generating a movement waveform 104. Here, only some of the vertical motions are noise whereas the main curves that are roughly parallel to the surface 101 reflect the actual displacement of the person.

In the examples of both FIGS. 1A and 1B, the inertial measurements may be dependent on the orientation or location of the IMU. It can be helpful, therefore, to convert the acceleration data of the inertial measurement to the standard coordinates of the earth (i.e. the ground coordinates or the earth coordinates). One such conversion method is illustrated in the following equation:

$$[ \begin{matrix}{a}_{x}^{G} \\ {a}_{y}^{G} \\ {a}_{z}^{G}\end{matrix} ] = [ \begin{matrix}- sin ( x ) * sin ( y ) * sin ( z ) + cos ( x ) * cos ( z ) & - cos ( y ) * sin ( z ) & - cos ( x ) * sin ( y ) * sin ( z ) - sin ( x ) * cos ( z ) \\ sin ( x ) * sin ( y ) * cos ( z ) + cos ( x ) * sin ( z ) & cos ( y ) * cos ( z ) & cos ( x ) * sin ( y ) * cos ( z ) - sin ( x ) * sin ( z ) \\ sin ( x ) * cos ( y ) & - sin ( y ) & cos ( y ) * cos ( x )\end{matrix} ] [ \begin{matrix}{a}_{x}^{B} \\ {a}_{y}^{B} \\ {a}_{z}^{B}\end{matrix} ]$$

where aₓ^{G}, a_{y}^{G}, and a_{z}^{G} represent the components for the acceleration estimated in the ground coordinates based on the measured acceleration components aₓ^{B}, a_{y}^{B} and a_{z}^{B} in the body coordinates.

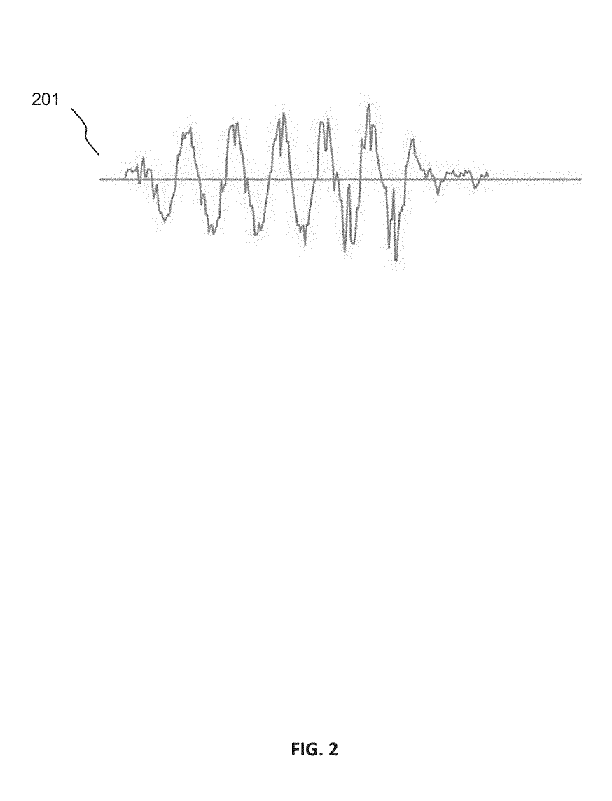

For a walking person, the converted acceleration data may look like curve 201 in FIG. 2. In this example, the high-frequency (narrow) peaks and valleys may be caused by vibrations of the IMU. It can be helpful, therefore, to reduce such noise before using the acceleration data to determine the movement characteristics useful for determining the displacement of the moving object.

Noise reduction for the acceleration data can use various known technologies that are optionally configured for a specific situation here. In one example, the data set that represents the measured acceleration information is processed with a smoothing technology. Non-limiting examples of smoothing technologies include additive smoothing, Butterworth filter, digital filter, exponential smoothing, Kalman filter, kernel smoother, Kolmogorov-Zurbenko filter, Laplacian smoothing, local regression, low-pass filter, Ramer-Douglas-Peucker algorithm, Savitzky-Golay smoothing filter, smoothing spline, stretched grid method, and the combinations thereof.

In some instances, the smoothing technology employs the use of a low-pass filter. The low-pass filter can be a first-order filter or a second-order filter. Specific examples of low-pass filters include, without limitation, a Butterworth filter, a Chebyshev filter, an Elliptic filter, a Bessel filter, a Gaussian filter, a Legendre filter or a Linkwitz-Riley filter.

In addition or alternatively, noise reduction of the acceleration data can be achieved by curve fitting. Non-limiting examples of curve fitting methods include polynomial interpolation, polynomial regression, trigonometric function fitting, Gaussian fitting, Lorentzian fitting, Voigt fitting, parametric curve fitting, and combinations thereof.

For either the smoothing or the curve fitting methodology, it can be useful to configure the methodology with a movement model suitable for the moving object. In one embodiment, the smoothing or curve fitting is configured to ensure preservation of the target frequencies and filter out noise frequencies. Thresholds for determining the target frequencies and noise frequencies can be predetermined or calculated on the fly. For instance, for a person that walks at a typical speed, a low pass filter can be configured to pass all signals having a frequency less than 0.5 Hz (i.e., fₚₐₛₛ=0.5 Hz) as the primary frequency, and stop all signals having a frequency higher than 0.8 Hz (i.e., fₛₜₒₚ=0.8 Hz). In this example, signals between these two frequencies are reduced but not eliminated.

In some implementations, the fₚₐₛₛ can be from about 0.3 Hz to about 0.7 Hz, or from 0.35 Hz to about 0.65 Hz, or from about 0.4 Hz to about 0.6 Hz, or from about 0.45 Hz to about 0.55 Hz, or at about 0.5 Hz. In some implementations, the fₛₜₒₚ can be from about 0.6 Hz to about 1 Hz, from about 0.65 Hz to about 0.95 Hz, from about 0.7 Hz to about 0.9 Hz, from about 0.75 Hz to about 0.85 Hz, or at about 0.8 Hz.

The target frequency can also be determined on the fly. In one example, the target frequency can be determined with a line that intersects with the acceleration curve. An example of the line is the x-axis as shown in FIG. 2, where the acceleration is 0. In this example, the target frequency is determined by an interval between two adjacent intersection points on the line.

In another example, the target frequency is determined by transforming the data set into a frequency domain. The transformation can be Fourier transformation, in one example. Then, the target frequency can be determined to be correspondent to one or more frequencies with the highest magnitude.

From the acceleration curve, movement characteristics of the moving object can be readily derived. The movement characteristics may include speed and direction of the movement. The speed, for instance, can be calculated as the area under the curve with an integral function. Such movement characteristics can then readily be used to calculate a displacement of the moving object.

The displacement determined from the movement characteristics derived from the inertial measurements (referred to herein also as “IM displacement”) can occur more frequently than that of the approximate displacement. Like the approximate displacement, the inertial measurements can also have errors. Unlike the approximate displacement, the errors associated with the IM displacement may accumulate when the multiple, consecutive IM displacements are combined.

In some instances, therefore, the IM displacement and the approximate displacement can be used to verify or adjust each other to arrive at an estimated displacement of high frequency and high accuracy. Two example methods to combine the IM displacement and the approximate displacement are described below. It is to be understood that the verification or adjustment does not need to occur at each time when an inertial measurement is made. For instance, in the example of FIG. 1A, verification or adjustment can be made at time point Hn/L2 where both an IM displacement and an approximate displacement are measured. No such verification or adjustment is needed at time points H2 to Hn−1.

When an IM displacement is measured, in some instances, an error can be estimated for the IM displacement. One factor that can be considered for estimating the error is the level of noise (e.g., vertical or side movements) in the inertial measurements. The more noise present in the inertial measurement, the more error that can be introduced during noise reduction. Another factor is certain irregularity of the object's movement. The irregularity may be the result of the error or reflection of error.

For the measurement of the approximate displacement, an error may be known or can be calculated. For instance, if the approximate displacement is obtained by a GPS receiver associated with the moving object, the strength of the GPS signal received at the GPS receive can be a good indicator of the level of error. Likewise, if the approximate displacement is provided by an UAV tracking the moving object, the quality of tracking can be estimated as well, which can then be used to estimate the error.

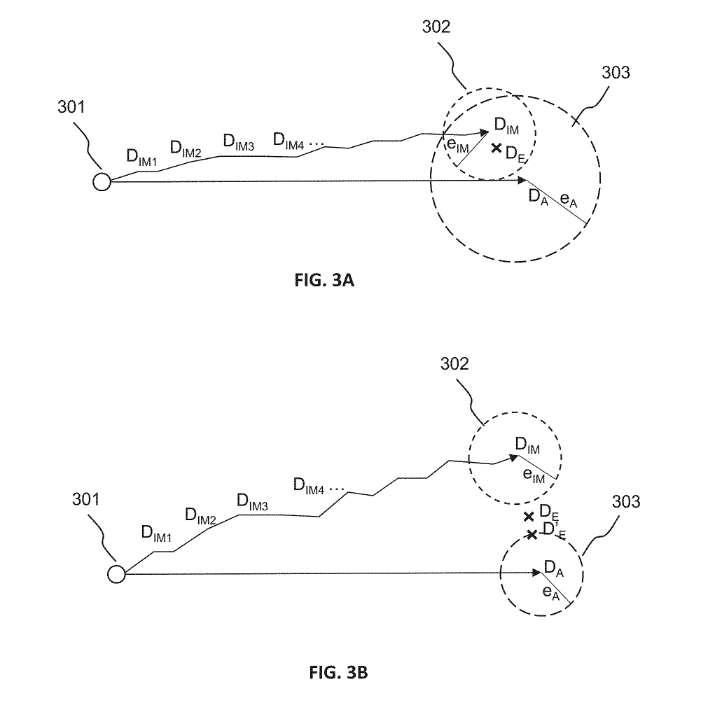

Between the IM displacement and the approximate displacement, the one with lower estimated error can be given higher weight when they are combined to produce the combined estimated displacement. With reference to FIG. 3A, at a first time point, the moving object is determined to be at location 301. After a period of time, at the second time point, the approximate displacement estimates that the moving object has moved to location D_{A}. Associated with this estimation, the approximate displacement has an estimated error of e_{A}. Circle 303 illustrates a range of possible actual locations of the moving object given the estimated error.

With the inertial measurements, the moving objet is estimated to have moved along a plurality of locations D_{IM1}, D_{IM3}, D_{IM3}, D_{IM4} . . . to arrive at location D_{IM}. An error for such measurements is estimated to be e_{IM}. Circle 302 illustrates the range of error. In this example, an estimated displacement/location (D_{E}) can be calculated that combines D_{A} and D_{IM} proportionally according to their respective accuracies (or inverse-proportionally according to their respective errors). Therefore, in this example, as e_{A} is greater than e_{IM}, the estimated displacement D_{E} is closer to D_{IM} than to D_{A}.

In the example illustrated in FIG. 3B, the approximate displacement measurement is estimated to have a relatively small error (e_{A}), and the calculated estimated displacement D_{E} is outside the circle 303. Accordingly, in accordance with some embodiments of the technology, the estimated displacement is further shifted towards D_{A} such that it is located within the circle 303. The resulting, updated estimated displacement is D′_{E}.

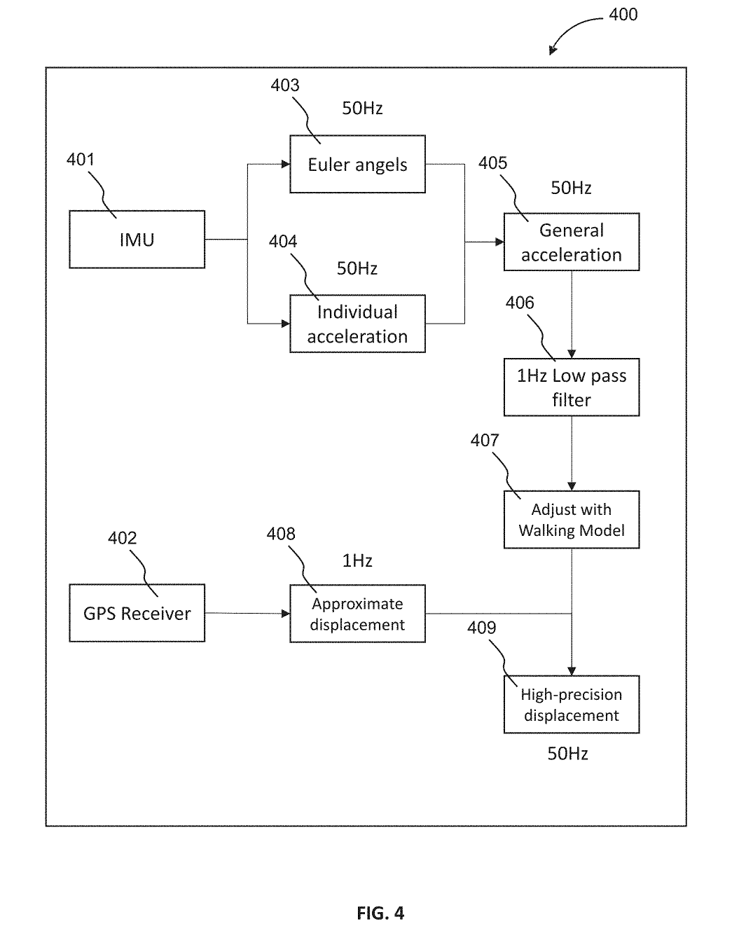

FIG. 4 presents an example workflow 400 for one embodiment of the presently described methodology. A GPS receiver 402 associated with a moving object is used to determine an approximate displacement (408) of the moving object from a first time point to a second time point. The GPS measurement takes place relatively infrequently, e.g., at about 1 Hz, which means that the second time point is least about 1 second after the first time point.

Meanwhile, an inertial measurement unit (IMU) 401 is used to measure individual accelerations (404) of the moving object at three Euler angels (403). Such measurement can happen more frequently relatively to that of the approximate displacement. As shown here, the frequency of the inertial measurements is about 50 Hz. The individual accelerations can be combined and converted to general acceleration (405) within the standard coordinates of the earth to adjust for the orientation of the IMU device.

The converted general acceleration data can then be subjected to the application of a low pass filter (407) that removes or reduces high frequency (e.g., >1 Hz) noise likely caused by movements of the moving object not in the direction to the next location. Application of the low pass filter can take into consideration of a walking model (407, such as movement style and frequency) if the moving object is a walking person. The filtered inertial measurements can then be used to calculate the movement characteristics of the moving object, such as the moving speed and direction. The speed and direction are then used to estimate a displacement of the moving object.

The estimated displacement from the GPS unit has relatively low frequency or is resistant to accumulative error; the displacement estimated from the inertial measurement can occur more frequently. Therefore, when such estimates are combined, a high-frequency and high-precision estimate of the displacement can be made (409).

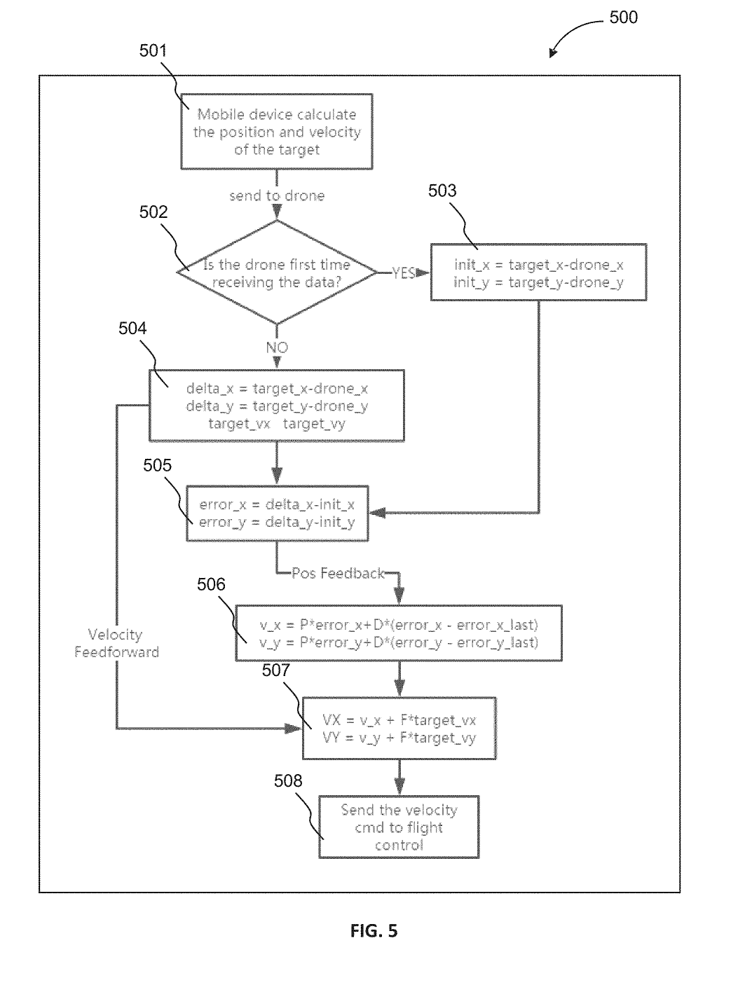

Determination of the displacement of the moving object can then be used to adjust the movement of a tracking platform (e.g., an UAV) such that the tracking platform can keep a relatively constant distance (and/or direction) to the moving target. An example method for the adjustment is illustrated in FIG. 5. Suppose Target_x, target_y, target_vx, and target_vy represent the location and speed in a two dimensional space parallel to a surface (e.g. a horizontal plan represented by x and y axis); and init_x and init_y represent the initial (or desired) relative location of the moving object (i.e. the target) as relative to the tracking platform. Further, delta_x and delta_y are used to represent the relative location of the moving object at a given time point, which can be calculated based on the displacement of the moving object. One example objective of the tracking is to maintain this relation location. Another example objective is to keep the flight direction (and the orientation of the tracking platform) towards the moving object.

In the flow chart 500 in FIG. 5, at step 501, the position and velocity of the moving object are measured with a mobile device (a smart phone or a wearable device) associated with the moving object. Such a position may be an absolute position (i.e., relative to the ground), and is transmitted to a drone which is an example of the tracking platform. If this is the first time when such data are received after tracking is initiated (502), the data can be used to set the tracking objective, that is, for the tracking platform to maintain the relative location to the moving object. Accordingly, the relative location (init_x and init_y) of the moving object is determined by comparing to the absolute location of the drone (drone_x and drone_y), at step 503.

If the init_x and init_y are already set, then the relative location (delta_x and delta_y) of the moving object is calculated (see 504). The difference between the desired relative location (init_x and init_y) and the current relative location (delta_x and delta_y) is calculated and referred to as error_x and error_y (505). At step 506, the difference (error_x and error_y) is used to determine the new speed of the tracking platform (v_x and v_y) such that the new speed will help reduce the difference to zero. Also taken into consideration in step 506 is the difference (error_x_last and error_y_last) from last adjustment. The equation used in FIG. 5 at step 506 is a proportional-integral-derivative controller method where P and D can be empirically determined.

At step 507, a velocity feedforward is employed. The velocity feedforward takes into account the speed of the moving object (target_vx and target_vy) weighted by a feedforward parameter F which can also be empirically determined. The final speed of the tracking platform (VX and VY) is then provided to the flight control center (508) of the drone to direct the flight of the drone.

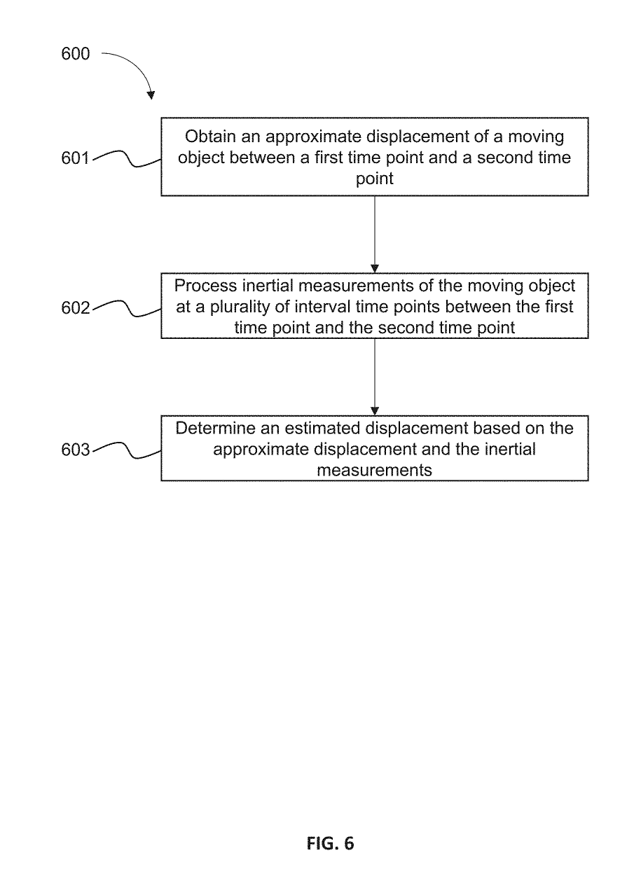

FIG. 6 shows a flow chart 600 illustrating a method for locating a moving object. The method entails, for example, obtaining an approximate displacement of the moving object between a first time point and a second time point, based on location measurements of the moving object at the first time point and the second time point (601), processing inertial measurements of the moving object at a plurality of interval time points between the first time point and the second time point to acquire movement characteristics of the moving object between the first time point and the second time point (602) and determining an estimated displacement of the moving object at a said interval time point between the first time point and the second time point, based on the acquired movement characteristics of the moving object and the approximate displacement of the moving object between the first time point and the second time point (603).

In some embodiments, the approximate displacement is obtained with a global positioning system (GPS) receiver. In some embodiments, the GPS receiver is configured to operate in a global navigation satellite system (GNSS). In some embodiments, the GNSS is selected from the group consisting of the United States Global Positioning System (GPS), the Global Navigation Satellite System (GLONASS), the Indian Regional Navigation Satellite System (IRNSS), the Chinese BeiDou Navigation Satellite System (BeiDou-2), and the European Galileo navigation satellite system (GALILEO).

In some embodiments, the inertial measurements are obtained with a sensing unit (sensor). In some embodiments, the sensing unit comprises an inertial measurement unit (IMU). In some embodiments, the IMU comprises an accelerator, gyroscope, a magnetometer, or a combination thereof.

In some embodiments, the moving target is or is associated with a walking or running individual. In some embodiments, the movement characteristics comprise a speed and a direction of the speed. In some embodiments, the movement characteristics further characterize movements in a side direction different from the direction. In some embodiments, the side direction is perpendicular to the direction.

In some embodiments, the method further entails filtering out noise in a data set representing the inertial measurements. In some embodiments, the data set represents accelerations. In some embodiments, the filtering uses a method selected from the group consisting of additive smoothing, Butterworth filter, digital filter, exponential smoothing, Kalman filter, kernel smoother, Kolmogorov-Zurbenko filter, Laplacian smoothing, local regression, low-pass filter, Ramer-Douglas-Peucker algorithm, Savitzky-Golay smoothing filter, smoothing spline, stretched grid method, and the combinations thereof.

In some embodiments, the filtering comprises application of a low-pass filter. In some embodiments, the low-pass filter is configured to filter out signals with a frequency higher than an upper cut-off frequency. In some embodiments, the low-pass filter is configured to filter out signals with a frequency lower than a lower cut-off frequency. In some embodiments, the upper cut-off frequency is between about 0.7 Hz and about 0.9 Hz. In some embodiments, the lower cut-off frequency is between about 0.4 Hz and about 0.6 Hz. In some embodiments, the low-pass filter is a first-order filter or a second-order filter. In some embodiments, the low-pass filter is a Butterworth filter, a Chebyshev filter, an Elliptic filter, a Bessel filter, a Gaussian filter, a Legendre filter or a Linkwitz-Riley filter.

In some embodiments, the method further entails determining a target frequency of the data set. In some embodiments, the target frequency is used to configure the filtering. In some embodiments, the filtering is low-pass filtering.

In some embodiments, the target frequency is determined by intersecting a curve representing the data set with a line. In some embodiments, the line is an x-axis of the curve where acceleration equals 0. In some embodiments, the target frequency is determined by an interval between two adjacent intersection points on the line.

In some embodiments, the target frequency is determined by transforming the data set into a frequency domain. In some embodiments, the transformation comprises Fourier transformation. In some embodiments, the target frequency is determined to be correspondent to one or more frequencies with the highest magnitude.

In some embodiments, the method further entails curve fitting a data set representing the inertial measurements. In some embodiments, the curve fitting uses a method selected from the group consisting of polynomial interpolation, polynomial regression, trigonometric function fitting, Gaussian fitting, Lorentzian fitting, Voigt fitting, parametric curve fitting, and combinations thereof.

In some embodiments, the inertial measurements are obtained at a frequency that is at least 10 Hz. In some embodiments, the inertial measurements are obtained at a frequency that is at least 40 Hz. In some embodiments, the second time point is at least 1/n second after the first time point, wherein n is at least 2 Hz.

In some embodiments, the moving characteristics comprise a speed calculated from the integral of the data set. In some embodiments, the method further entails calculating an inertial measurement displacement (IM displacement) based on the moving characteristics. In some embodiments, the determination of the estimated displacement comprises fusing the IM displacement and the approximate displacement.

In some embodiments, the method further entails calculating the estimated error for the IM displacement. In some embodiments, the method further entails updating the estimated displacement to be within a range defined by the approximate displacement and the estimated error for the IM displacement thereof.

Also provided, like the method of any of the above embodiments, is a system for locating a moving object, comprising a processor and program instructions which, when executed by the processor, configure the system to obtain an approximate displacement of the moving object between a first time point and a second time point, based on location measurements of the moving object at the first time point and the second time point, process inertial measurements of the moving object at a plurality of interval time points between the first time point and the second time point to acquire movement characteristics of the moving object between the first time point and the second time point, and determine an estimated displacement of the moving object at a said interval time point between the first time point and the second time point, based on the acquired movement characteristics of the moving object and the approximate displacement of the moving object between the first time point and the second time point.

Also provided, like the method of any of the above embodiments, is a non-transitory computer readable medium program instructions which when executed configure a system to obtain an approximate displacement of the moving object between a first time point and a second time point, based on location measurements of the moving object at the first time point and the second time point, process inertial measurements of the moving object at a plurality of interval time points between the first time point and the second time point to acquire movement characteristics of the moving object between the first time point and the second time point, and determine an estimated displacement of the moving object at a said interval time point between the first time point and the second time point, based on the acquired movement characteristics of the moving object and the approximate displacement of the moving object between the first time point and the second time point.

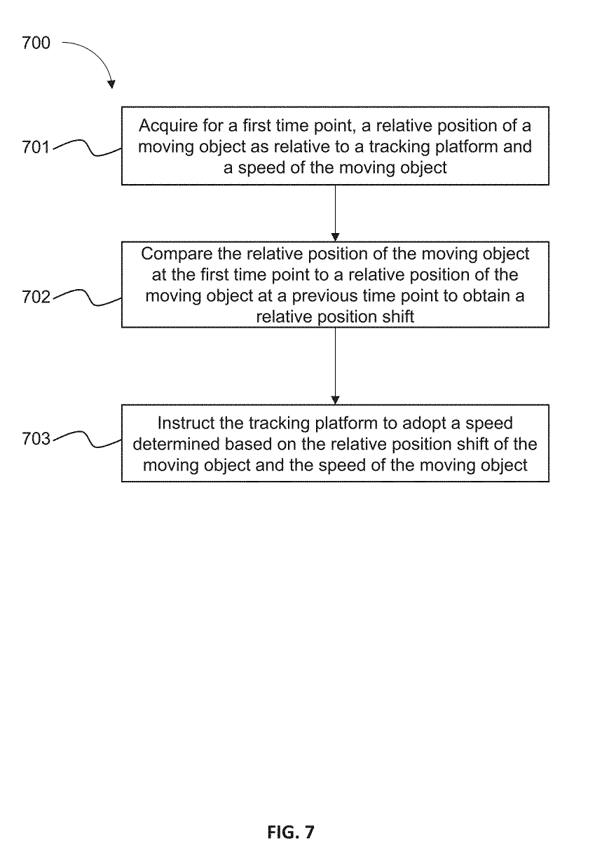

FIG. 7 shows a flow chart 700 illustrating a method for tracking a moving object. The method, for example, entails acquiring, for a first time point (current time point), a relative position of a moving object as relative to a tracking platform and a speed of the moving object (701), comparing the relative position of the moving object at the first time point to a relative position of the moving object at a previous time point (such a relative position is also referred to as a “previous relative position”) to obtain a relative position shift (702), and instructing the tracking platform to adopt a speed determined based on the relative position shift of the moving object and the speed of the moving object (703).

In another embodiment, provided is a system comprising a processor and program instructions that configure the system to acquire, for a first time point, a relative position of a moving object as relative to a tracking platform and a speed of the moving object, compare the relative position of the moving object at the first time point to a relative position of the moving object at a previous time point to obtain a relative position shift, and instruct the tracking platform to adopt a speed determined based on the relative position shift of the moving object and the speed of the moving object.

In some embodiments, the determination is further based on a relative position shift acquired at the previous time point. In some embodiments, the determination comprises obtaining a difference between the relative position shift at the first time point and the relative position shift at the previous time point. In some embodiments, the determination comprises processing the relative position shift at the first time point and the relative position shift at the previous time point with a proportional-integral-derivative (PID) controller. In some embodiments, the determination comprises applying a feed-forward coefficient associated with the speed of the moving object. In some embodiments, the speed of the tracking platform and the speed of the moving object are relative to ground.

In some embodiments, the program instructions further instruct the tracking platform to adjust a direction towards the moving object when needed. In some embodiments, the system comprises the tracking platform. In some embodiments, the tracking platform comprises an unmanned aerial vehicle (UAV) or a road vehicle. In some embodiments, the tracking platform comprises a sensor for acquiring a location of the moving object. In some embodiments, the sensor comprises an image sensor, an infrared sensor, or an ultrasound sensor.

In some embodiments, the system further includes a remote device in communication with the moving object. In some embodiments, the remote device is configured for determining a position and speed of the moving object.

In some embodiments, the determination comprises locating the moving object by obtaining an approximate displacement of the moving object between a first time point and a second time point, based on location measurements of the moving object at the first time point and the second time point, processing inertial measurements of the moving object at a plurality of interval time points between the first time point and the second time point to acquire movement characteristics of the moving object between the first time point and the second time point, and determining an estimated displacement of the moving object at a said interval time point between the first time point and the second time point, based on the acquired movement characteristics of the moving object and the approximate displacement of the moving object between the first time point and the second time point.

In some embodiments, the approximate displacement is obtained with a global positioning system (GPS) receiver disposed in the remote device. In some embodiments, the inertial measurements are obtained with a sensing unit (sensor) disposed in the remote device. In some embodiments, the sensor comprises an inertial measurement unit (IMU).

In some embodiments, the movement characteristics comprise a speed and a direction of the speed. In some embodiments, the locating further comprises filtering out noise in a data set representing the inertial measurements. In some embodiments, the data set represents accelerations.

In some embodiments, the filtering uses a method selected from the group consisting of additive smoothing, Butterworth filter, digital filter, exponential smoothing, Kalman filter, kernel smoother, Kolmogorov-Zurbenko filter, Laplacian smoothing, local regression, low-pass filter, Ramer-Douglas-Peucker algorithm, Savitzky-Golay smoothing filter, smoothing spline, stretched grid method, and the combinations thereof.

In some embodiments, the filtering comprises application of a low-pass filter. In some embodiments, the low-pass filter is configured to filter out signals with a frequency higher than an upper cut-off frequency. In some embodiments, the low-pass filter is configured to filter signals with a frequency lower than a lower cut-off frequency.

In some embodiments, the filtering is configured with a target frequency of the data set. In some embodiments, the target frequency is determined by intersecting a curve representing the data set with a line. In some embodiments, the line is an x-axis of the curve where acceleration equals 0. In some embodiments, the target frequency is determined by an interval between two adjacent intersection points on the line. In some embodiments, the target frequency is determined by transforming the data set into a frequency domain. In some embodiments, the transformation comprises Fourier transformation. In some embodiments, the target frequency is determined to be correspondent to one or more frequencies with the highest magnitude.

In some embodiments, the inertial measurements are obtained at a frequency that is at least 10 Hz. In some embodiments, the inertial measurements are obtained at a frequency that is at least 40 Hz. In some embodiments, the second time point is at least 1/n second after the first time point, wherein n is at least 2 Hz.

In some embodiments, the moving characteristics comprise a speed calculated from the integral of the data set. In some embodiments, the locating further comprises calculating an inertial measurement displacement (IM displacement) based on the moving characteristics. In some embodiments, the determination of the estimated displacement comprises fusing the IM displacement and the approximate displacement. In some embodiments, the locating further comprises calculating the estimated error for the IM displacement. In some embodiments, the locating further comprises updating the estimated displacement to be within a range defined by the approximate displacement and the estimated error for the IM displacement thereof. In some embodiments, the remote device is configured to be coupled to the moving object.

Also provided, in one embodiment, is a non-transitory computer readable medium, comprising program instructions which when executed configure a tracking platform to acquire, for a first time point, a relative position of a moving object as relative to the tracking platform and a speed of the moving object; compare the relative position of the moving object at the first time point to a relative position of the moving object at a previous time point to obtain a relative position shift; and instruct the tracking platform to adopt a speed determined based on the relative position shift of the moving object and the speed of the moving object.

Systems, apparatuses, non-transitory computer-readable media are also provided that support or implement various methods and techniques of the present disclosure. For instance, one embodiment provides a system for supporting aerial operation over a surface, comprising a processor and instructions which, when executed by the processor, operate to: obtain a representation of the surface that comprises a plurality of flight sections; and identify a flight path that allows an aircraft, when following the flight path, to conduct an operation over each flight section.

Another embodiment provides a system for acquiring a target for a movable object, comprising a processor and instructions which, when executed by the processor, operate to provide, in response to receiving an initialization signal, a solicitation signal; detect an action by one or more potential candidates in response to the solicitation signal; and identify a target from the one or more potential candidates based on the detected action.

Another embodiment provides a system for directing movement of individuals, comprising a processor and instructions which, when executed by the processor, operate to: detect an event associated with a group of individuals; generate a movement signal based on the detected event; and provide the movement signal to the individuals.

Another embodiment provides a non-transitory computer-readable medium for acquiring a target for a movable object, comprising instructions stored therein, wherein the instructions, when executed by a processor, perform the steps of: providing, in response to receiving an initialization signal, a solicitation signal; detecting an action by one or more potential candidates in response to the solicitation signal; and identifying a target from the one or more potential candidates based on the detected action.

Another embodiment provides a non-transitory computer-readable medium for directing movement of individuals, comprising instructions stored herein, wherein the instructions, when executed by a processor, performs the steps of: detecting an event associated with a group of individuals; generating a movement signal based on the detected event; and providing the movement signal to the individuals.

Another embodiment provides a system for acquiring a target for a movable object, comprising: a processor; a first module configured to provide, in response to receiving an initialization signal, a solicitation signal; a second module configured to detect an action by one or more potential candidates in response to the solicitation signal; and a third module configured to identify a target from the one or more potential candidates based on the detected action.

Another embodiment provides a system for directing movement of individuals, comprising: a processor; a first module configured to detect an event associated with a group of individuals; a second module configured to generate a movement signal based on the detected event; and a third module configured to provide the movement signal to the individuals. Another embodiment provides a system for acquiring a target for a movable object, comprising a processor, means for providing, in response to receiving an initialization signal, a solicitation signal, means for detecting an action by one or more potential candidates in response to the solicitation signal, and means for identifying a target from the one or more potential candidates based on the detected action.

Another embodiment provides a system for directing movement of individuals, comprising a processor, means for detecting an event associated with a group of individuals, means for generating a movement signal based on the detected event, and means for providing the movement signal to the individuals.

Features of the present disclosure can be implemented in, using, or with the assistance of a computer program product which is a storage medium (media) or computer readable medium (media) having instructions stored thereon/in which can be used to program a processing system to perform any of the features presented herein. The storage medium can include, but is not limited to, any type of disk including floppy disks, optical discs, DVD, CD-ROMs, microdrive, and magneto-optical disks, ROMs, RAMs, EPROMs, EEPROMs, DRAMs, VRAMs, flash memory devices, magnetic or optical cards, nanosystems (including molecular memory ICs), or any type of media or device suitable for storing instructions and/or data.

Stored on any one of the machine readable medium (media), features of the present disclosure can be incorporated in software and/or firmware for controlling the hardware of a processing system, and for enabling a processing system to interact with other mechanism utilizing the results of the present disclosure. Such software or firmware may include, but is not limited to, application code, device drivers, operating systems and execution environments/containers.

Features of the disclosure may also be implemented in hardware using, for example, hardware components such as application specific integrated circuits (ASICs) and field-programmable gate array (FPGA) devices. Implementation of the hardware state machine so as to perform the functions described herein will be apparent to persons skilled in the relevant art.

Additionally, the present disclosure may be conveniently implemented using one or more general purpose or specialized digital computer, computing device, machine, or microprocessor, including one or more processors, memory and/or computer readable storage media programmed according to the teachings of the present disclosure. Appropriate software coding can readily be prepared by skilled programmers based on the teachings of the present disclosure, as will be apparent to those skilled in the software art.

While various embodiments of the present disclosure have been described above, it should be understood that they have been presented by way of example, and not limitation. It will be apparent to persons skilled in the relevant art that various changes in form and detail can be made therein without departing from the spirit and scope of the disclosure.

The present disclosure has been described above with the aid of functional building blocks illustrating the performance of specified functions and relationships thereof. The boundaries of these functional building blocks have often been arbitrarily defined herein for the convenience of the description. Alternate boundaries can be defined so long as the specified functions and relationships thereof are appropriately performed. Any such alternate boundaries are thus within the scope and spirit of the disclosure.

The foregoing description of the present disclosure has been provided for the purposes of illustration and description. It is not intended to be exhaustive or to limit the disclosure to the precise forms disclosed. The breadth and scope of the present disclosure should not be limited by any of the above-described exemplary embodiments. Many modifications and variations will be apparent to the practitioner skilled in the art. The modifications and variations include any relevant combination of the disclosed features. The embodiments were chosen and described in order to best explain the principles of the disclosure and its practical application, thereby enabling others skilled in the art to understand the disclosure for various embodiments and with various modifications that are suited to the particular use contemplated. It is intended that the scope of the invention be defined by the following claims and their equivalence.

1. A method for locating a moving object, comprising:
obtaining an approximate displacement of the moving object between a first time point and a second time point, based on location measurements of the moving object at the first time point and the second time point;
processing inertial measurements of the moving object at a plurality of interval time points between the first time point and the second time point to acquire movement characteristics of the moving object between the first time point and the second time point; and
determining an estimated displacement of the moving object at one of the interval time points between the first time point and the second time point, based on the acquired movement characteristics of the moving object and the approximate displacement of the moving object between the first time point and the second time point.

2. The method of claim 1, wherein the approximate displacement is obtained with a global positioning system (GPS) receiver.

3. The method of claim 1, wherein the inertial measurements are obtained by a sensor.

4. The method of claim 3, wherein the sensor comprises an inertial measurement unit (IMU).

5. The method of claim 1, wherein the movement characteristics comprise a speed and a direction of the speed.

6. The method of claim 5, wherein the movement characteristics further characterize movements in a side direction perpendicular to the direction of the speed.

7. The method of any one of claim 1, further comprising filtering out noise in a data set representing the inertial measurements, wherein the data set represents accelerations.

8. The method of claim 7, wherein the filtering comprises application of a low-pass filter, configured to filter out signals with a frequency higher than an upper cut-off frequency.

9. The method of claim 7, further comprising determining a target frequency of the data set by intersecting a curve representing the data set with a line.

10. The method of claim 9, wherein the line is an x-axis of the curve where acceleration equals 0, and wherein the target frequency is determined by an interval between two adjacent intersection points on the line.

11. The method of claim 9, wherein determining the target frequency comprises:
transforming the data set into a frequency domain;
determining the target frequency to be correspondent to one or more frequencies with a highest magnitude.

12. The method of claim 1, further comprising curve fitting a data set representing the inertial measurements.

13. The method of claim 1, further comprising calculating an inertial measurement displacement (IM displacement) based on the moving characteristics, wherein determining the estimated displacement comprises fusing the IM displacement and the approximate displacement.

14. A system for locating a moving object, comprising:
a processor; and
a memory storing program instructions that, when executed by the processor, configure the system to:
obtain an approximate displacement of the moving object between a first time point and a second time point, based on location measurements of the moving object at the first time point and the second time point;
process inertial measurements of the moving object at a plurality of interval time points between the first time point and the second time point to acquire movement characteristics of the moving object between the first time point and the second time point; and
determine an estimated displacement of the moving object at one of the interval time points between the first time point and the second time point, based on the acquired movement characteristics of the moving object and the approximate displacement of the moving object between the first time point and the second time point.

15. A system comprising:
a processor; and
a memory storing program instructions that, when executed by the processor, configure the system to:
acquire, for a time point, a relative position of a moving object as relative to a tracking platform and a speed of the moving object;
compare the relative position of the moving object at the time point to a relative position of the moving object at a previous time point to obtain a relative position shift of the moving object; and
instruct the tracking platform to adopt an updated speed determined based on the relative position shift of the moving object and the speed of the moving object.

16. The system of claim 15, wherein the updated speed is determined further based on a previous relative position shift acquired at the previous time point.

17. The system of claim 16, wherein determining the updated speed comprises obtaining a difference between the relative position shift at the time point and the previous relative position shift at the previous time point.

18. The system of claim 17, wherein determining the updated speed further comprises processing the relative position shift at the time point and the previous relative position shift at the previous time point with a proportional-integral-derivative (PID) controller.

19. The system of claim 15, wherein the tracking platform comprises an unmanned aerial vehicle (UAV) or a road vehicle.

20. The system of claim 15, wherein the tracking platform comprises an image sensor, an infrared sensor, or an ultrasound sensor.
